(19) United States
(12) Patent Application Publication
(10) Pub. No.: US 2025/0222705 A1
(43) Pub. Date: Jul. 10, 2025

(54) BOARD SECTIONS FOR MEDIA COLLECTION

(71) Applicant: Hewlett-Packard Development Company, L.P., Spring, TX (US)

(72) Inventors: Wesley CHIA, Singapore (SG); Rodrigo RUIZ RESTOY, Sant Cugat del Valles (ES); Marta RAMIS LLINARES, Sant Cugat del Valles (ES); Wei Lit TEOH, Singapore (SG)

(73) Assignee: Hewlett-Packard Development Company, L.P., Spring, TX (US)

(21) Appl. No.: 18/851,312

(22) PCT Filed: Mar. 30, 2022
(86) PCT No.: PCT/US2022/022481

§ 371 Date: Sep. 26, 2024

(51) Int. Cl. B41J 13/10; B41J 11/66

(52) U.S. Cl. CPC B41J 13/106; B41J 11/66

(57) ABSTRACT

In an example, a media handling device (100) comprises a media catcher (110) defining a first media collecting width (112) along a lateral direction. The device also comprises a first board section (120) defining a second media collecting width (122) along the lateral direction, the second media collecting width exceeding and at least partially overlapping the first media collecting width, and a second board section (130), whereby the first board section is at least partially located between the second board section and the media catcher, the first and second board sections forming an apex (125) along the second media collecting width to support media. The device further comprises an abutment (140) at a distal end of the first board section away from the apex, the abutment being located between the first board section and the media catcher.

### BACKGROUND

Media handling device may perform printed media handling operations for example in the printing, copying, publishing, marketing or packaging industries. Print media may for example enter an imaging device through a media input, and exit the imaging device through a media output after undergoing an imaging operation. Print media may be captured by an output tray or basket of a media handling device when exiting the imaging device.

### BRIEF DESCRIPTION OF THE DRAWINGS

Non-limiting examples will now be described with reference to the accompanying drawings, in which:

FIGS. 1A-D show schematic representations of example media handling devices.

FIG. 2 shows another schematic representation of an example media handling device.

FIG. 3 shows another schematic representation of an example media handling device.

FIG. 4 shows another schematic representation of an example media handling device.

FIG. 5 shows another schematic representation of an example media handling device.

FIG. 6 shows another schematic representation of an example media handling device.

FIGS. 7A-B show schematic representations of another example media handling device.

FIG. 8 shows another schematic representation of an example media handling device.

FIGS. 9A-C show schematic representations of other example media handling devices.

FIG. 10 shows a schematic representation of an example imaging device.

FIG. 11 shows another schematic representation of an example imaging device.

FIG. 12 shows another schematic representation of an example imaging device.

FIG. 13 shows a schematic flow chart of an example method.

FIG. 14 shows a schematic flow chart of another example method.

FIG. 15 shows a schematic flow chart of another example method.

### DETAILED DESCRIPTION

Different devices may handle media in the form of sheets, for example for printing, binding, classifying, dispatching, packaging or copying such media. Such media handling may sometimes be configured to handle different media sizes. Such a capability for handling different media sizes forms the foundation of the present disclosure.

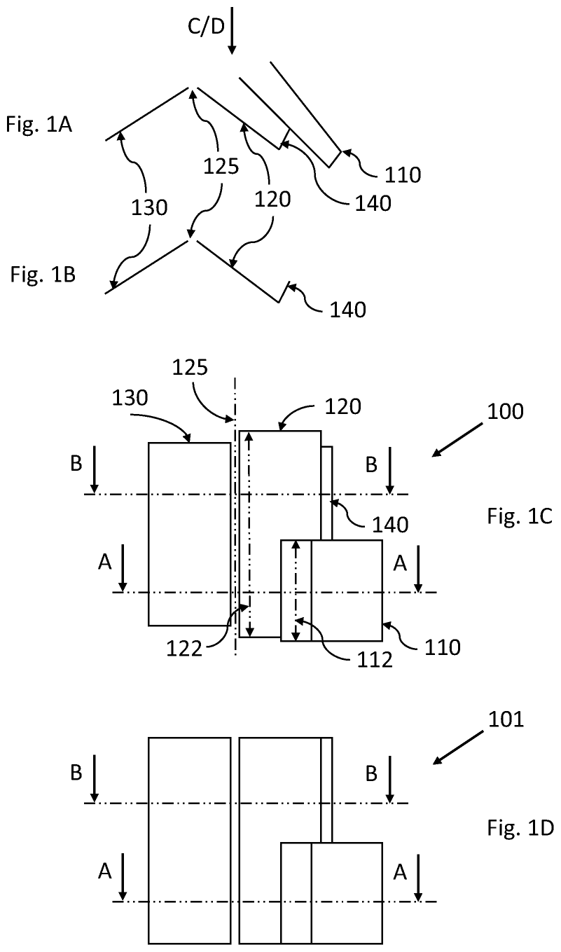

FIGS. 1A-C illustrate an example media handling device 100. Media according to this disclosure should be understood as a generally two dimensional media having a width, a length and a thickness, the thickness being very significantly smaller than both of the width and the length, the thickness being for example of less than 100 times either of the length or width. The media may be provided as a precut sheet or as a roll. The media may comprise cellulose fiber, polymeric fibers, natural fibers, or a combination of these. The media may be a laminate. The media may be a paper based media or a textile media, being a woven or non-woven textile media. In some examples, the media is provided in the form of a roll and has a nominal media width, at rest, of at least 900 mm, of at least 1000 mm or of at least 1200 mm. In some examples, the media is provided in the form of a precut sheet and has a nominal media width, at rest, of less than 900 mm, of less than 600 mm, of less than 425 mm, of less than 300 mm or of less than 211 mm. In some examples, the media is a printing media configured to be processed by an imaging device in order to print a digital representation on the printing media.

A media handling device according to this disclosure should be understood as a device configured to mechanically manipulate and collect media. In some examples, the handling device is one of a media classifier, media collecting device or media storing device. such media handling device may be self-standing or may be a component of an apparatus such as an imaging device, for example.

Example media handling device 100 is represented in FIG. 1C in a top view configuration along the direction C/D illustrated in FIG. 1A. Example media handling device 100 is represented in FIG. 1A as a side view along plane A illustrated in FIG. 1C. Another side view of the same handling device 100 is represented in FIG. 1B, along a plane B illustrated in FIG. 1C.

Example media handling device 100 comprises a media catcher 110 defining a first media collecting width 112 along a lateral direction. In some examples, the lateral direction is a direction perpendicular to a media advance direction as the media is handled by the device. A media catcher should be understood as a component of the handling device forming a depression or a cavity configured to receive media handled by the device in such a way that the received media may lay flat in the media catcher, and whereby a plurality of media sheets may pile up within the media catcher. In some examples, the media catcher is a media pocket which comprises a single opening on a top side of the pocket, media getting inserted through such single opening into the media pocket and being stored into such media pocket by gravity. In other examples, the media catcher comprises a tray for supporting the media. In some examples, the first media collecting width is of less than 900 mm, of less than 600 mm, of less than 425 mm, of less than 300 mm or of less than 211 mm.

Example media handling device 100 comprises a first board section 120 defining a second media collecting width 122 along the lateral direction, the second media collecting width exceeding and at least partially overlapping the first media collecting width 112. Such second media collecting width corresponds to the collecting of media having a relatively larger format than media collected by the media catcher. In some examples, the second media collecting width is of at least 900 mm, of at least 1000 mm or of at least 1200 mm. The at least partial overlap between the first and second media collecting width permits obtaining a relatively compact media handling device while offering different media collecting possibilities. In some examples, the overlap is of more than 50%, of more than 70%, of more than 90% or of 100% of the first media collecting width along the lateral direction. A board section (whether first or second, or whether front or back) according to this disclosure should be understood as a generally planar and relatively rigid surface on which media may be supported. In some examples, a board section is made from a plastic material, from wood or from metal. In some examples, the board section comprises apertures, for example in order to reduce board weights, in order to foment media drying, or in order to both reduce board weight and foment media drying. In some examples, a board section, while being generally planar in order to avoid generating folds in supported media, may be slightly curved, slightly convex or slightly concave. A board section may be self-standing, or may be linked to or integral to another board section. In some examples, a board section has a generally rectangular shape matching the shape of a media sheet. In some examples, a board section has a length along the lateral direction of more than 900 mm, of more than 1000 mm or more than 1200 mm. In some examples, a board section has a width along a direction perpendicular to the lateral direction of more than 400 mm, of more than 500 mm or more than 600 mm. As will be described in more details below, the first board section participates in collecting relatively large media, such media being large in relation to media collected in the catcher. One should note that while FIG. 1A is a side view along a plane A where the first and second media collecting width overlap, FIG. 1B is a side view along a plane B where the first and second media collecting width do not overlap. Catcher 110 is thereby not visible in FIG. 1B.

Example media handling device 100 comprises a second board section 130, whereby the first board section 120 is at least partially located between the second board section 130 and the media catcher 110, the first 120 and second board 130 sections forming an apex 125 along the second media collecting width 122 to support media. In this example, the first and second board sections are represented as separated board sections. In other examples, such first and second board sections may be linked, or form an integral board including the apex. The apex should be understood as a crest or ridge defining an elongated top area (the top being normally defined, in relation to the direction of gravity when the media handling device is in an operating position), the apex being formed for example by inclination of the first and second board sections, each board section having a top edge, the top edges meeting to form the apex. In some examples, the apex is formed by a junction of the first and second board portions along the lateral direction. In some examples, the apex is formed by a region proximate to the first and second board portion, such region corresponding to a space or slot separating the first and second board portions in the apex region. In some examples, an additional component defines the apex in a region where the first and second board sections meet. In some examples, the apex defines a surface having a radius of curvature around an axis parallel to the lateral direction. In some examples, the radius of curvature is of no less than 5 mm, of no less than 10 mm, of no less than 20 mm or of no less than 25 mm. A higher radius of curvature is less likely to lead to damaging a media sheet at the apex. The apex runs along the second media collecting width and is thereby along the lateral direction. The configuration of the first board section, second board section and of the apex permits supporting one or more sheets of media, such sheets of media being relatively large compared to sheets of media collected in the media catcher. Such apex configuration permits obtaining both stability and compactness for media collection, each such relatively large media sheet lying against the first board section, second board section and apex in a piling up configuration. One should note that such a configuration avoids collection of such sheets in a roll form, whereby collection in a roll form may lead to creasing in cases of a roll getting completely or partially smashed, for example by other rolls in cases of numerous relatively large media sheets being collected together in a roll form. The first board section 120 is at least partially located between the second board section 130 and the media catcher 110, such that, seen from the top of the media handling device in operating position, the apex would be located between the first and second board portions, and the first board portion between the apex and the media catcher. In some examples, a tray part of the media catcher facing the first board portion and the first board portion itself make an acute angle between each other, in some examples an acute angle of less than 45 degrees, of less than 30 degrees, of less than 20 degrees, or of less than 10 degrees. Such a configuration contributes to limiting a footprint of the media handling device. In some examples, part of the media catcher and part of the first board section overlap in a vertical direction of gravity when the media handling device is in operating position. In some examples, a tray part of the media catcher facing the first board portion, on a first hand, and the second board portion, on a second hand, make an obtuse angle between each other, in some examples an obtuse angle of more than 90 degrees, of more than 120 degrees or of more than 150 degrees.

Example media handling device 100 comprises an abutment 140 at a distal end of the first board section away from the apex, the abutment being located between the first board section and the media catcher. Such abutment is configured to receive a leading edge of a media sheet which would slide between the first board section and the media catcher, without entering the media catcher, the first board section facing the media catcher. In examples of a relatively large media sheet, in particular a media sheet having a length in excess of a distance between the apex and the abutment, such relatively large media sheet would, once reaching on one end the abutment, flip on the other end above the apex and fall onto the second board section to lie on both board sections and on top of the apex between them in an inverted “V” configuration. In some examples, the abutment runs all along the lateral direction and all along a distal end of the first board section away from the apex. In some examples, as illustrated in FIG. 1C, the abutment is located along a portion of the distal end of the first board section away from the apex. In some examples, the abutment comprises a plurality of separate sections spread along the lateral direction. In some examples, the abutment comprises a single piece. In some examples, the abutment extends away from a surface of the first board section configured to receive media by a specific distance, and extends toward the media catcher. In some examples, such specific distance is of more than 1 cm, of more than 3 cm, of more than 5 cm, of more than 10 cm or of more than 15 cm. A longer specific distance contributes to ensuring abutment of a leading edge of media onto the abutment. A shorter specific distance contributes to limiting a foot print of the media handling device. In some examples, the abutment spans a distance of no less than 100%, no less than 90% or no less than 80% of a distance separating the first board section from the media catcher at the distal end of the first board section away from the apex, the first board section and the media catcher forming a funnel directing media outside of the media catcher (i.e. media destined to be collected onto the apex, first and second board sections) towards the abutment when the media handling device is in an operating position.

Another example media handling device 101 is represented in FIG. 1D. This example media handling device comprises the components as described in the context of media handling device 100, in the configuration as described in FIGS. 1A and 1B. Differences between example device 101 and example device 100 are as follow:
the first board section, apex, second board section and abutment have in example device 101 a same length along the lateral direction;
the second media collecting width completely overlaps the first collecting width, and
both the first media output width and the second media output width start from a same point. Further configurations may be considered. Some configurations may contribute to reducing a foot print of the media handling device. Some configurations may be particularly adapted to integrating the media handling device into a device such as an imaging device.

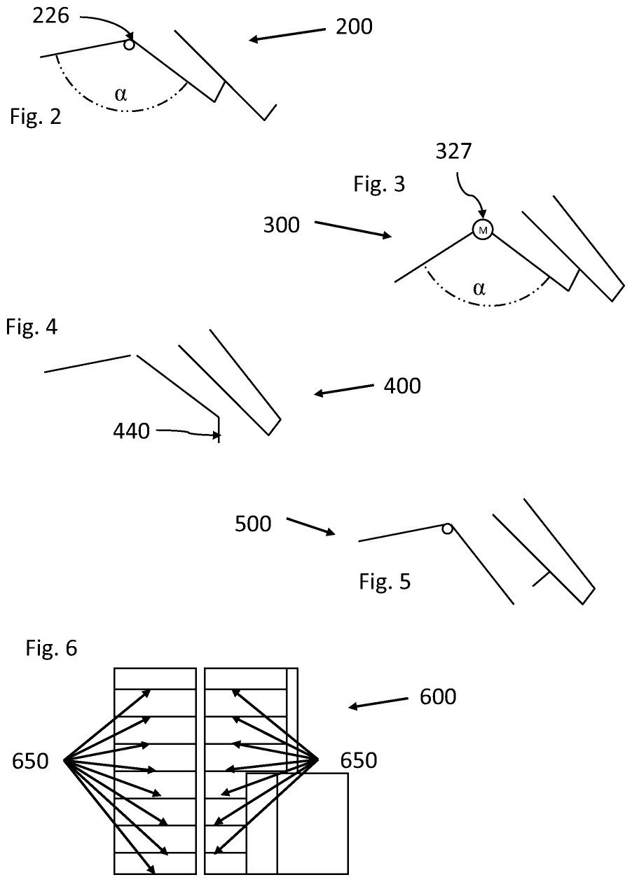

FIG. 2 illustrates, as viewed in FIG. 1A, another example media handling device 200. Device 200 comprises the components as described for example in the context of FIGS. 1A-D which are not discussed here in details. Media handling device 200 further comprises a hinge 226 connecting the first board section and the second board section at the apex. Such hinge permits setting an angle α between the first and the second board sections. The hinge may in some examples be operated by a user. The hinge may in some examples be configured to provide specific predetermined angular positions. In some examples, the hinge permits moving both the first and the second board sections in relation to a referential linked to the media catcher. In some examples, the hinge limits movement to the first board section, the second board section remaining fixed in relation to a referential linked to the media catcher. In some examples, the hinge limits movement to the second board section, the first board section remaining fixed in relation to a referential linked to the media catcher. Limiting hinge movements to a specific board section or to specific angular positions may render the media handling device operation more reliable and sturdier. Extending hinge movements of both the first and second board sections or to a continuous range of angular position may offer additional flexibility to a user of the media handling device. The introduction of a hinge such as hinge 226 permits setting or changing a foot print of the media handling device, and permits accommodating collecting of different media sizes, leading to collecting longer media sizes by increasing the angle between the first and second board portions. In some examples, a long media sheet may have a length along a length direction perpendicular to the lateral direction exceeding a length of both board sections along that same length lateral direction, such long media sheet hanging out from an end of the second board section distal from the apex. In such cases of a long media sheet hanging out, increasing the angle α may prevent the long media sheet from coming into contact with the floor at its hanging end (the hanging end being opposed to another end of the sheet on an opposed abutment side).

FIG. 3 illustrates, as viewed in FIG. 1A, another example media handling device 300. Device 300 comprises the components as described for example in the context of FIGS. 1A-D which are not discussed here in details. Device 300 further comprises a motorized hinge 327 which offers configurations discussed in the context of hinge 226, such motorized hinge 327 permitting an automated hinge operation, for example to change, using a controller of the media handling device connected to a motor of the hinge, an angle between the front and back board sections, for example as a function of a media length or of a media stiffness, whereby a wider angle corresponds to a longer media length or to a stiffer media. The motor of the hinge may have functions other than powering hinge rotation.

FIG. 4 illustrates, as viewed in FIG. 1A, another example media handling device 400. Device 400 comprises the components as described for example in the context of FIGS. 1A-D which are not discussed here in details. While not illustrated, device 400 may further comprise a hinge such as hinge 226 or such as hinge 327. In device 400, the abutment 440 is retractable, and is represented in a retracted position. When not retracted, abutment 440 operates as described in the context of FIGS. 1A-D for abutment 140. When retracted, a media sheet which would otherwise be collected onto the apex, first and second board sections may be permitted to slide along and beyond the first board section, getting accumulated by gravity below the end of the first board section distal from the apex. This may be appropriate to handle particularly long media sheets exceeding in length a length collecting capacity of the first and second board sections. In some examples, the abutment may be retractable manually. In some examples, the abutment may be retractable by operation of a motor, which maybe controlled by a controller of the media handling device.

FIG. 5 illustrates, as viewed in FIG. 1A, another example media handling device 500. Device 500 comprises the components as described for example in the context of FIGS. 1A-D which are not discussed here in details. In device 500, the abutment is fixedly connected to the media catcher. As illustrated, device 500 further comprises a hinge such as hinge 226 or such as hinge 327. In the example illustrated, the hinge permits removing the first board portion away from the media catcher, and thereby away from the abutment, rendering such abutment retractable, permitting handling particularly long media sheets as described in the context of a retractable abutment described in the context of FIG. 4. In other non-illustrated examples, the abutment is fixedly connected to the media catcher in a media handling device without hinge between the first and second board sections.

FIG. 6 illustrates, as viewed in FIGS. 1C or 1D, another example media handling device 600. Device 600 comprises the components as described for example in the context of FIGS. 1A-D which are not discussed here in details. While not illustrated, device 600 may comprise a hinge such as hinge 226 or hinge 327, may comprise a retractable abutment as described in the context of device 400, and may comprise an abutment fixedly connected to the media catcher as discussed in the context of FIG. 5. As illustrated, in device 600 the board sections comprise ridges 650 on a media facing surface of the board sections. Such ridges permit reducing a direct surface of contact between a collected media and the board sections and may contribute to accelerating drying of a media sheet. Reducing such direct surface of contact may reduce introducing defects on a recently printed media for example, in particular in a configuration whereby a recently printed side of the media is facing the board sections. In some examples, not illustrated here, such ridges are solely provided on one of the first or second board sections. In some examples, the ridges are evenly spread across the board sections. In some examples, the ridges are along a direction corresponding to a media advance direction. In some examples, not illustrated here, the ridges comprise curved sections. In some examples, the ridges extend away and upwards from a bord section by no more than 3 cm, no more than 2 cm or no more than 1 cm.

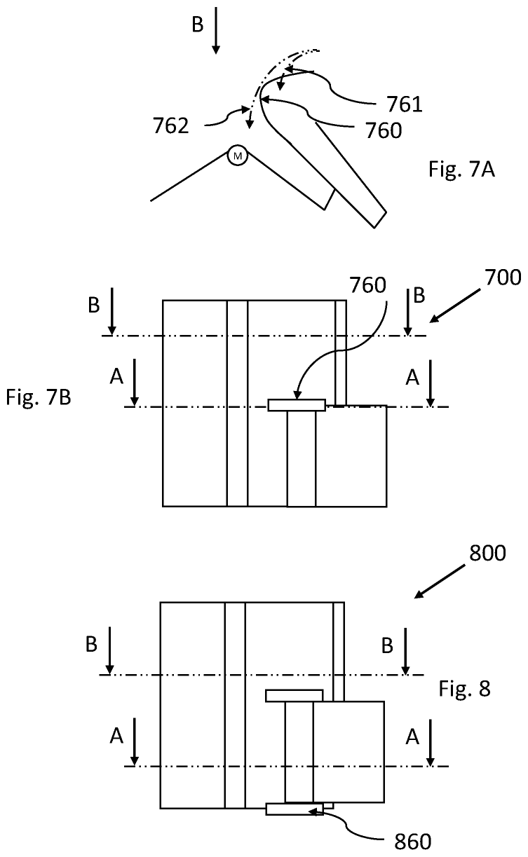

FIGS. 7A (in the manner of FIG. 1A) and 7B (in the manner of FIG. 1C) illustrate an example media handling device 700. While FIG. 7B represents device 700 along plane A illustrated in FIG. 7A and intersecting both the media catcher and the first, second board sections and apex, a view along plan B illustrated in FIG. 7B would not intersect the media catcher and would appear as illustrated in FIG. 1B. Device 700 comprises the components as described for example in the context of FIGS. 1A-D which are not discussed here in details. Device 700 may comprise a hinge such as hinge 226 or hinge 327 (as illustrated here), may comprise a retractable abutment as described in the context of device 400, and may comprise an abutment fixedly connected to the media catcher as discussed in the context of FIG. 5. Device 700 may also comprise one or more board sections comprising ridges such as ridged 650 on a media facing surface of the one or more board sections.

Device 700 further comprises a first guiding rail 760 separating a first media path 761 from a second media path 762, the first media path leading to the media catcher and the second media path leading to the first and second board sections, the first guiding rail being located at least partially upstream from the apex along the second media path, the first guiding rail being located at least partially along the second media path, the first guiding rail being located away from the first media collecting width along the lateral direction. Due to the first guiding rail 760 being located away from the first media collecting width along the lateral direction, the guiding rail will not interfere with the trajectory of a media sheet to be collected along the first media collecting width. Due to the first guiding rail being located at least partially along the second media path, the guiding rail will however interfere with a media sheet to be collected along the second media collecting width, coming in the way of such media sheet as the media sheet advances, such media sheet sliding against the guiding rail. Due to the first guiding rail being located at least partially upstream from the apex along the second media path, a leading edge of a media sheet to be collected along the second media collecting width will slide along the first board section towards the abutment after sliding past the guiding rail. In other words, while a media sheet to be collected along the first media collecting width will follow the first media path without interacting with the guiding rail, a media sheet to be collected along the second media collecting width will follow the second media path due to an interaction with the guiding rail situated away from a region in which the first and second media collecting width overlap. An example guiding rail contributes to selectively directing media sheet either towards the media catcher (and its first media collecting width) or towards the apex, first and second board sections forming the second media collecting width.

FIG. 8 illustrates (in a manner similar to FIG. 7B) an example media handling device 800. The description of device 700 applies to device 800. Device 800 further comprises a second guiding rail 860 separating the first media path from the second media path, whereby the first media collecting width is comprised between the first and the second guiding rails. Second guiding rail 860 may be of a same nature as first guiding rail 760, guiding rail 860 being shifted along the lateral direction compared to the first guiding rail 760. Providing such a second guiding rail contributes to reliably and selectively direct a media sheet either towards the media catcher (and its first media collecting width) or towards the apex, first and second board sections forming the second media collecting width by providing additional support to a media sheet to be collected at the second media collecting width.

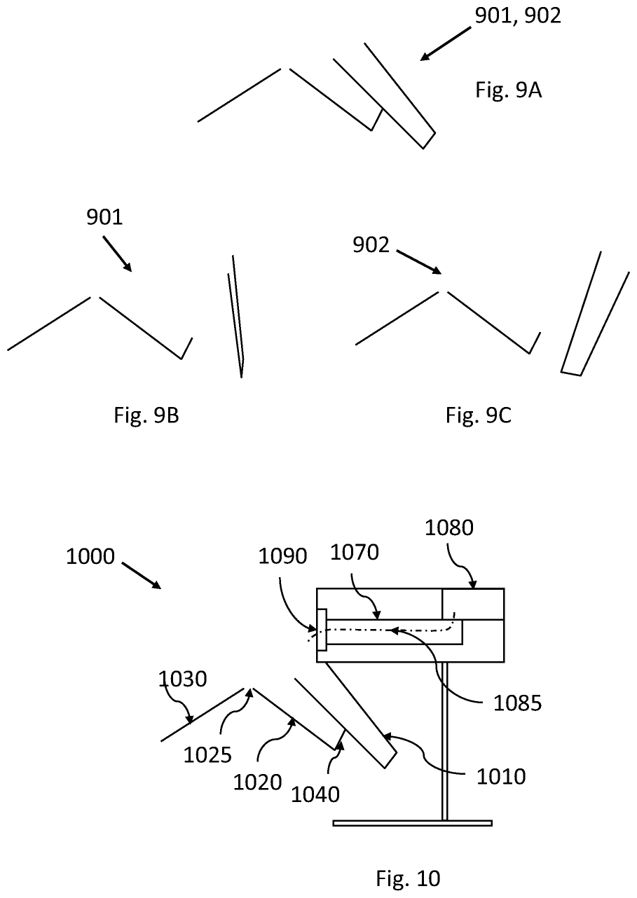

FIGS. 9A-C illustrate two different example media handling devices 901 and 902, viewing them as represented for example in FIG. 1A. Device 901 is represented in a first configuration in FIG. 9A and in a second configuration in FIG. 9B. Device 902 is represented in a first configuration in FIG. 9A (same as for device 901) and in a second configuration in FIG. 9C. Media handling devices 901 and 902 each comprise the components as described for example in the context of FIGS. 1A-D which are not discussed here in details. While not illustrated, devices 901 and 902 may comprise a hinge such as hinge 226 or hinge 327, may comprise a retractable abutment as described in the context of device 400, may comprise an abutment fixedly connected to the media catcher as discussed in the context of FIG. 5, and may comprise ridges such as ridges 650 on a media facing surface of one or both of the board sections. In example devices 901 and 902, the media catcher is retractable. Providing a retractable media catcher permits removing the media catcher from a media path leading to the first media collecting width, such that a media sheet advancing in the media handling device with retracted media catcher would not be led to the first media collecting width and could for example be led to the second media collecting width. Such retractable media catcher permits selectively directing media sheet either towards the media catcher (and its first media collecting width), when the media catcher is in an operating (not retracted) position, or towards the apex, first and second board sections forming the second media collecting width by retracting the media catcher. The media catcher is illustrated as retracted in FIG. 9B by folding of the media catcher in device 901. The media catcher is illustrated as retracted in FIG. 9C by shifting or rotating the media catcher in device 902 away from the media path. In FIG. 9A, applying to both devices 901 and 902, the media catcher is in operating position, i.e. not retracted. Folding, shifting or rotating the media catcher may be done by manually or in a motorized manner.

FIG. 10 illustrates an example imaging device 1000. An imaging device may perform imaging operations such as printing, scanning or copying with print media in a form of media sheets. The imaging device comprises an imaging component 1070. In some examples, the imaging component is an optical scanner. In some examples, the imaging component is a printhead. The printhead may be a fixed printhead such as a so called “page wide array” printhead or may be a so called “scanning printhead” moving back and forth along a lateral direction to print a digital representation on a media sheet using printing fluid.

The imaging device comprises a media input 1080 disposed on a back side of the imaging component and a media output 1090 disposed on a front side of the imaging component, wherein a media path 1085 extends from the media input, through the imaging component, to the media output, following a media advance direction. The wording “front” and “back” should be understood as relative to each other in reference to the imaging component in order to define the media path 1085, the back corresponding to a region upstream from the imaging component and the front to a region downstream from the imaging component from a media advance direction point of view.

In addition to these components, the imaging device comprises:
a media catcher 1010 defining a short media output width along a lateral direction;
a back board section 1020 defining a long media output width along the lateral direction, the long media output width at least partially overlapping the short media output width;
a front board section 1030, whereby the back board section is at least partially located between the front board section and the media catcher, the back and front board sections forming a ridge 1025 along the long media output width to support media; and
a media blocker 1040 at a distal end of the back board section away from the ridge, the media blocker being located between the back board section and the media catcher.

Media catcher 1010 may correspond to any one of the media catchers described in example media handling devices hereby described. Back board section 1020 may correspond to any of the first board sections described in example media handling devices hereby described. Front board section 1030 may correspond to any of the second board sections described in example media handling devices hereby described, such front board section being named in this manner whereby it is facing a user coming to collect one or more media sheets processed by the imaging component. Ridge 1025 is formed by an apex as in example media handling devices hereby described. Media blocker 1040 is formed by an abutment as in example media handling devices hereby described.

In other words, example imaging device 1000 comprises an image component, a media input and a media output as well as a media handling device as any of the example media handling devices described hereby.

In some examples, an imaging device such as imaging device 1000 comprises a scanning printhead moving back and forth from a first extreme position and a second extreme position along the lateral direction, whereby both the short media output width and the long media output width start from a same one of the first or second extreme positions, as illustrated for example in FIGS. 1D, 6 or 7B, this in order to reduce printhead movement when printing on a media sheet by avoiding printhead travel to reach an area corresponding to one of the media output width.

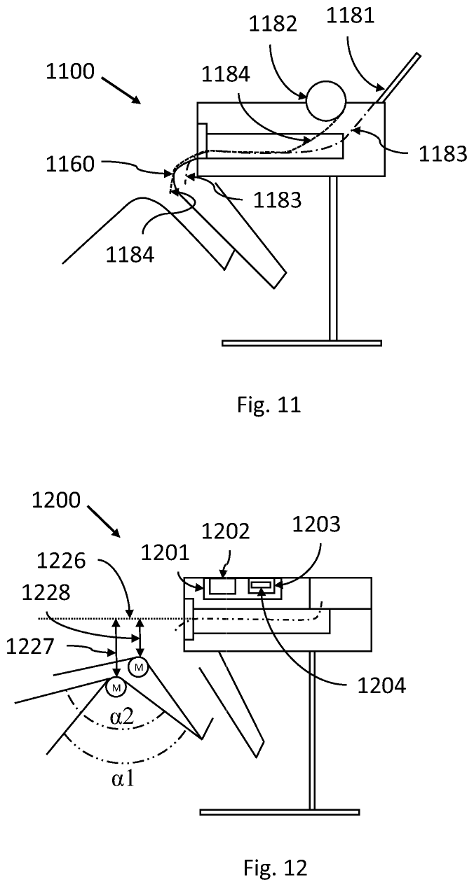

FIG. 11 illustrates an example imaging device 1100. Example imagining device comprises the components of imaging device 1000 as described in the context of FIG. 10 which are not discussed here in details. In example device 1100, the media input comprises both a precut sheet media input 1181 and a media roll media input 1182. Example imaging device 1100 further comprises one or more guiding rails 1160 as described in the context of media handling device 700 or of media handling device 800. In some examples, media input as a precut sheet through media input 1181 has a media width along the lateral direction shorter than media input from a media roll at media input 1182. In such examples, a first media path 1183 originates from the precut sheet media input 1181, through the imaging component, and into the media catcher without interaction with the one or more guiding rails 1160. In such examples, a second media path 1184 originates from the media roll media input 1182, through the imaging component, and onto the apex, first board section and second board section after interacting with the one or more guiding rails 1160. In this example, media path selection is obtained by the guiding rails. In other examples, a retractable media catcher may be used to obtain media path selection.

In this example device 1100, while the apex, back board section and front board sections are made of a single integral piece curved at the apex, other configurations as described hereby may be used. Such a monolithic construction of the apex, first board section and second board sections may be used in example hinge-less media handling devices according to this disclosure.

FIG. 12 illustrates an example imaging device 1200. Example imagining device comprises the components of imaging device 1000 as described in the context of FIG. 10 which are not discussed here in details. While not illustrated, imaging device 1200 could also comprise components 1181, 1182 and 1160 of imaging device 1100. Imaging device 1200 further comprises comprising a controller 1201, the controller comprising a processor 1202, storage 1203 coupled to the processor 1202, and an instruction set 1204 to cooperate with the processor and the storage to change one or more of:
an angle α between the front and back board sections, for example as a function of a media length or media stiffness, whereby a wider angle can correspond to a longer media length, to a stiffer media, or both; and
a vertical distance between the ridge and a media output level.
   In this example, the imaging device 1200 comprises a motorized hinge such as motorized hinged 327 described in the context of FIG. 3, such motorized hinge being controlled by the controller 1201. The device 1200 is represented with a retracted media catcher, but other alternatives such as guiding rails may be considered to obtain selectivity as to media path selection according to this disclosure. Device 1200 is represented in alternative angular positions, a first angular position α1 reducing the foot print of the imaging device, a second position α2, whereby α2>α1, for collecting particularly long media sheet onto the apex, front and back board portions, an end of such particularly long media sheet distal from an end of the same sheet in abutment with the media stopper hanging off the front board portion. The second position α2, with a broader angle between board sections compared to first position α1, may also permit handling relatively stiffer media while reducing a risk of an undesired deformation of such stiffer media. Example particularly long media sheets may have a length in a direction of media advance of more than 1 m, a combined length of both board sections summing for example less than 1 m in order to limit footprint.

In some examples, in particular as illustrated in FIG. 12, a specific vertical distance between the ridge and a media output level may be set. A media output level should be understood as the level of a horizontal plane 1226 comprising a level at which the media is output at the front side of the imaging component. Such media output level may for example be tangent to a sheet of media being output at the front side of the imaging component. In some examples, using different angular positions of the front and back board sections (respectively second and first board sections), between each other and in relation to a fixed referential of the imaging component, permits setting different such distances between the apex or ridge in relation to such media output level, permitting for example collecting sheets of a particular length while avoiding or reducing a risk that such sheets may get soiled or otherwise damaged by hanging out off the front or second board section down onto such floor, or permitting collecting sheets having a specific stiffness, whereby increasing the vertical distance between the apex or ridge in relation to such media output level may permit handling stiffer media by reducing a risk of folding such stiffer media in an undesired manner when such media is flipped over such ridge or apex. An example of such reduced distance between the apex or ridge in relation to such media output level 1226 is represented in FIG. 12 as distance 1228, such distance 1228 being shorter than the corresponding distance 1227 represented with angles α1 and α2. While illustrated in the context of FIG. 12, such setting of distance may take place in different configurations according to this disclosure, with manual hinge or with motorized hinge for example.

In some examples, in particular as illustrated in FIG. 12, an instruction set 1204 is to cooperate with the processor and the storage to change both an angle α between the front and back board sections and a vertical distance between the ridge and a media output level.

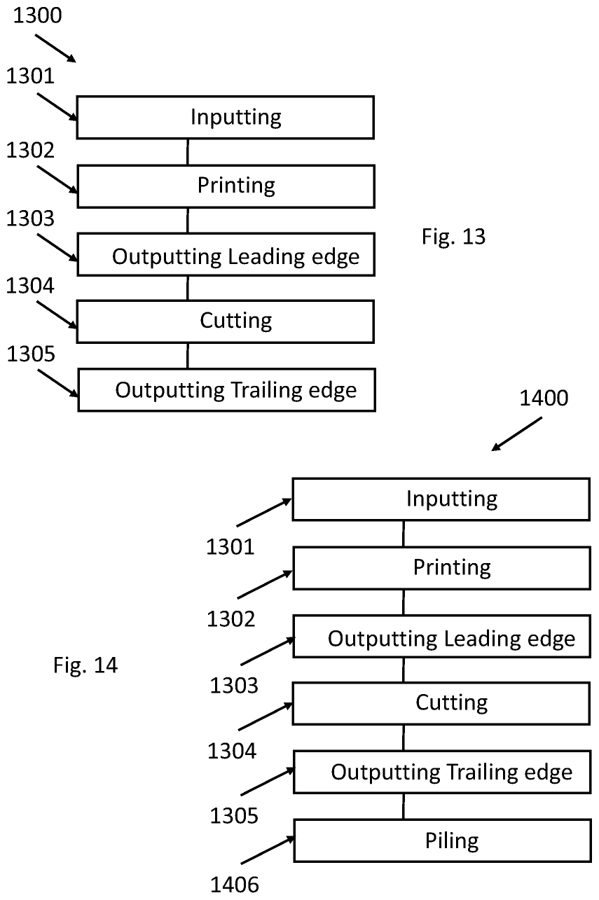

FIG. 13 illustrates an example method 1300 which may be used to operate any of the media handling devices or imaging devices hereby described. Method 1300 comprises, in a block 1301, inputting a roll sheet towards an imaging component of an imaging device from a media roll. A roll sheet should be understood as a sheet pulled from a media roll, for example a media roll used as media input 1182 of FIG. 11. Method 1300 further comprises, in a block 1302, printing, using the imaging component, a digital representation on a face of the roll sheet. Method 1300 further comprises, in block 1303, outputting a leading edge of the printed roll sheet along a first board section and up to an abutment. The leading edge should be understood as an edge of the sheet advancing along a media advance direction, the edge being parallel to a lateral direction perpendicular to the media advance direction. The outputting may for example take place at a media output such as media output 1090. Method 1300 further comprises, in block 1304, cutting a trailing edge of the printed roll sheet (the trailing edge being for a given sheet opposed to the leading edge), thereby separating the printed roll sheet from the roll. Such cutter may be located downstream from the imaging component, for example between the imaging component and a media output. In some examples, the cutting takes place using a blade travelling along a direction perpendicular to a media advance direction. Method 1300 further comprises, in block 1304, upon abutment of the leading edge, outputting the trailing edge over a ridge (such as 125 or 1025) and onto a second board section, the ridge being formed by the first and second board sections, the ridge being parallel to an axis of the media roll, the output cut roll sheet hanging, printed face down, onto the ridge, first and second board sections. One should note that blocks 1301 to 1305 may be operated by a controller such as, for example, controller 1201, such controller controlling the imaging component, media advance mechanisms and a cutting tool of the imaging device for example.

FIG. 14 illustrates an example method 1400 comprising blocks 1301-1305 described in the context of example method 1300. Method 1400 further comprises, in block 1406, piling a plurality of cut roll sheets up onto the ridge, first and second board sections. This permit collecting such cut roll sheets in an orderly fashion, in a reduced footprint, while avoiding damage to such sheets.

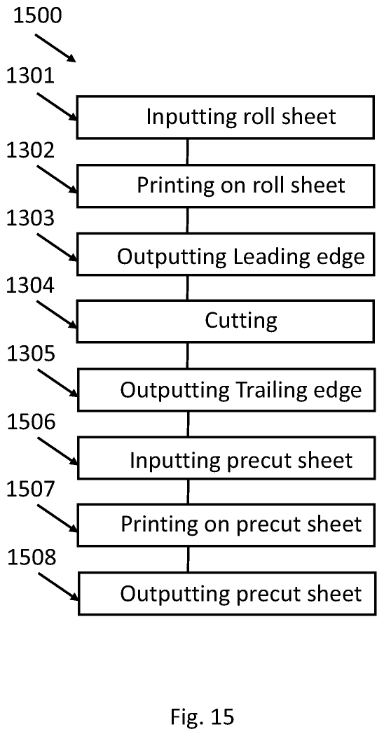

FIG. 15 illustrates an example method 1500 comprising blocks 1301-1305 described in the context of example method 1300. While not illustrated, example method may also comprise block 1406. Method 1500 further comprises, in a block 1506, inputting a precut sheet towards the imaging component from a precut sheet input tray of the imaging device. Such precut sheet may for example be input through a precut sheet media input such as media input 1181, for example a media input in the form of a tray. Method 1500 further comprises, in a block 1507, printing, using the imaging component, a digital representation on the precut sheet. Method 1500 also comprises, in block 1508, outputting the printed precut sheet in a precut sheet media catcher of the imaging device, the precut sheet media catcher being nested between the imaging component and the first board section. Such nesting may for example at least partially take place below the printing device as illustrated for example in FIGS. 10, 11 and 12, in order to reduce footprint.

It shall be understood that some blocks in the flow charts representing the example methods can be realized using machine readable instructions, such as any combination of software, hardware or firmware. Such machine readable instructions may be included on a non-transitory computer readable storage medium, such as storage 1203 for example, including but not limited to disc storage, CD-ROM or optical storage, having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A media handling device comprising:
a media catcher defining a first media collecting width along a lateral direction;
a first board section defining a second media collecting width along the lateral direction, the second media collecting width exceeding and at least partially overlapping the first media collecting width;
a second board section, whereby the first board section is at least partially located between the second board section and the media catcher, the first and second board sections forming an apex along the second media collecting width to support media; and
an abutment at a distal end of the first board section away from the apex, the abutment being located between the first board section and the media catcher.

2. The media handling device according to claim 1, further comprising:
a hinge connecting the first board section and the second board section at the apex.

3. The media handling device according to claim 2, whereby the hinge is a motorized hinge.

4. The media handling device according to claim 1, whereby the abutment is retractable.

5. The media handling device according to claim 1, whereby the abutment is fixedly connected to the media catcher.

6. The media handling device according to claim 1, whereby the board sections comprise ridges on a media facing surface of the board sections.

7. The media handling device according to claim 1, further comprising a first guiding rail separating a first media path from a second media path, the first media path leading to the media catcher and the second media path leading to the first and second board sections, the first guiding rail being located at least partially upstream from the apex along the second media path, the first guiding rail being located at least partially along the second media path, the first guiding rail being located away from the first media collecting width along the lateral direction.

8. The media handling device according to claim 7, further comprising a second guiding rail separating the first media path from the second media path, whereby the first media collecting width is comprised between the first and the second guiding rails.

9. The media handling device according to claim 1, whereby the media catcher is retractable.

10. An imaging device comprising:
an imaging component;
a media input disposed on a back side of the imaging component;
a media output disposed on a front side of the imaging component, wherein a media path extends from the media input, through the imaging component, to the media output;
a media catcher defining a short media output width along a lateral direction;
a back board section defining a long media output width along the lateral direction, the long media output width at least partially overlapping the short media output width;
a front board section, whereby the back board section is at least partially located between the front board section and the media catcher, the back and front board sections forming a ridge along the long media output width to support media; and
a media blocker at a distal end of the back board section away from the ridge, the media blocker being located between the back board section and the media catcher.

11. The imaging device according to claim 10, whereby the media input comprises both a precut sheet media input and a media roll media input.

12. The imaging device according to claim 10, further comprising a controller, the controller comprising a processor, a storage coupled to the processor, and an instruction set to cooperate with the processor and the storage to change one or more of:
an angle between the front and back board sections; and
a vertical distance between the ridge and a media output level.

13. A method comprising:
inputting a roll sheet towards an imaging component of an imaging device from a media roll;
printing, using the imaging component, a digital representation on a face of the roll sheet;
outputting a leading edge of the printed roll sheet along a first board section and up to an abutment;
cutting a trailing edge of the printed roll sheet; and
upon abutment of the leading edge, outputting the trailing edge over a ridge and onto a second board section, the ridge being formed by the first and second board sections, the ridge being parallel to an axis of the media roll, the output cut roll sheet hanging, printed face down, onto the ridge, first and second board sections.

14. The method according to claim 13, further comprising:
piling a plurality of cut roll sheets up onto the ridge, first and second board sections.

15. The method according to claim 13, further comprising:
inputting a precut sheet towards the imaging component from a precut sheet input tray of the imaging device;
printing, using the imaging component, a digital representation on the precut sheet; and
outputting the printed precut sheet in a precut sheet media catcher of the imaging device, the precut sheet media catcher being nested between the imaging component and the first board section.
